(19) United States
(12) Patent Application Publication
(10) Pub. No.: US 2009/0289432 A1
(43) Pub. Date: Nov. 26, 2009

(54) Flatbed supporting device

(76) Inventor: Yiang-Chou Liu, Taipei (TW)

Correspondence Address: BACON & THOMAS, PLLC, 625 SLATERS LANE, FOURTH FLOOR, ALEXANDRIA, VA, 22314-1176, US

(21) Appl. No.: 12/153,550

(22) Filed: May 21, 2008

(51) Int. Cl. B62B 1/02

(52) U.S. Cl. 280/79.11

(57) ABSTRACT

An invention of a flatbed supporting device is composed of a horizontal plate, a hydraulic cylinder, a supporting device, a fixing holder, a first holder & a second holder where the supporting device is made up of a steel connecting rod and a steel shaft being plugged into a hollow longitudinal casing pipe and a hollow lateral casing pip, which are welded on an assembled device and secured & positioned to a hydraulic cylinder with plural bolts for enhancement of supporting strength and inhibition of breaks in usage.

### BACKGROUND OF THE INVENTION

1. Field of the Invention

This new flatbed supporting device is an assistant tool used for reparation of motor vehicles in particular that enhance strength of a structure in usage and reduce costs and possibilities of unexpected accidents such as breaks or injuries.

2. Description of the Prior Art

For the purpose of maintaining a smooth driving and useable conditions of a motor vehicle, a regular maintenance for detailed inspections & calibrations and necessary replacement or addition of components is indispensable for keeping an optimal situation of a motor vehicle.

For the sake of simple reparation or maintenance of motor vehicles nowadays, a jack or a lift must be used for raising the vehicle. Furthermore, a lift employed for reparation or maintenance of motorcycles is made up of a platform, a scissor-type holder, a fixing holder, a hydraulic device, and a supporting device such as the platform support structure of the U.S. Pat. No. 6,345,693 that ensures ascending, descending, and location under sustaining weight of a motorcycle and provides convenient manners in reparation or maintenance for mechanics.

In addition, a general flatbed supporting device has a supporting device that is welded with iron materials for sustaining a hydraulic cylinder and causes breaks and even damages in usage due to low-strength iron that is easily welded and has low costs; steel material with high strength but features of difficult welding and high costs is not an ideal choice in usage. With this perception, higher strength for a supporting device in usage and no potential break and injury for reduction in costs deserve to an inventor's further exploration.

Hence, the inventor hopes to design a supporting device constructed via welding and screws for better strength and hardness by employing plural metals as base materials to link components together and installing plural bearings on both sides of the supporting device to assist slide of a scissor-type structure and reach a strong hardness and reduction in costs because of smooth ascending/descending and seldom breaks and damages.

### SUMMARY OF THE INVENTION

The major objective for this invention of a flatbed supporting device is to create a T-type iron-welded hollow assembled device that is engaged with a steel connecting rod and a steel shaft respectively and enhances strength of the moveable platform without bend, deformation, or breaks easily.

The structure of the flatbed supporting device is made up of a horizontal plate, a hydraulic cylinder, a supporting device, a fixing holder, a first holder, and a second holder where the supporting device is assembled with components manufactured by different materials for reduction of costs, reinforcement of durable features, and prevention of injuries to users. Thus, features of this invention can completely match demands for a patent application. With an illustration of diagrams, the detailed description and technical content related to this invention is displayed as follows:

### DETAILED DESCRIPTION OF THE PREFERRED EMBODIMENTS

Above all, refer to the content shown in FIG. 1 and FIG. 2 simultaneously. As an assistant tool for reparation or maintenance of motor vehicles or motorcycles, the invention is a flatbed supporting device 1, which is made up of a horizontal plate 10, a hydraulic cylinder 11, a supporting device 12, a fixing holder 13, a first holder 14, and a second holder 15. The horizontal plate 10 assembled with plural plates is equipped with a stationary barrier 101 at one end to sustain a motorcycle's wheels. As a buffer, the hydraulic cylinder 11 is equipped with plural positioning pins 111 placed in plural holes 1120 of a spacer 112 at one end and a connector 110 at another end for connection of the supporting device 12 that is a structure similar to a T-type rod-shaped object with plural bearings 123, 123′, 124, and 124′, which can be moved along curved bulges 140 of the first holder 14 as well as curved bulges 150 of the second holder 15, and with plural washers 125 and 125′ installed on two lateral ends blocked by C rings 126 & 126′ and is connected to the hydraulic cylinder 11 with its longitudinal end. With a shape approximating to a Π-type rod, the fixing holder 13 has L-type lateral lugs 130 & 130′, which are engaged to grooves 141 of the first holder 14 for fixing according to lifted heights. With a shape similar to a rectangle, the first holder 14 and the second holder 15 have shaft holes 144 & 154 respectively for penetration of a shaft bar 155 to form an approximate scissor-type holder. For both holders, the first holder 14 has plural grooves 141 on one side plus curved bulges 140 on another side and a hole 142 at one end for penetration of a crossbar 143, and the second holder 15 has curved bulges 150 on one side and is configured with plural wheels 151 & 151′ and plural gaskets 152 & 152′ fixed with C rings 153 & 153′. After extension of the supporting device 12 via a function of the hydraulic cylinder 11, plural bearings 123, 123′, 124, and 124′ can be moved along bulges 140 of the first holder 14 & bulges 150 of the second holder 15 to make the horizontal plate 10 shifted upward or downward and form the flatbed supporting device 1 by fixing the holder 13 at a necessary height corresponding to displacement.

Refer to the content shown in FIG. 3 and FIG. 4. The supporting device 12 has an assembled device 120 made up of a hollow longitudinal casing pipe 1201, a hollow lateral casing pipe 1202 and plural supporting plates 1203 welded with iron materials and has a steel connecting rod 121 & a steel shaft 122 for insertion of the longitudinal casing pipe 1201 & the lateral casing pipe 1202 where plural holes 1210 & 1210′ prepared at one end of the connecting rod 121 are corresponded to holes 12010 & 12010′ on the longitudinal casing pipe 1201 for secure connection with screwed plural bolts 12011 & 12011′. In addition, a shaft 122 has plural holes 1220 & 1220′ perpendicularly drilled on its surface and corresponded to plural holes 12020 & 12020′ on the lateral casing pipe 1202 for secure connection of screwed plural bolts 12021 and 12021′ and has grooves 1221 & 1221′ on its both ends for installation of plural bearings 123, 123′, 124, and 124′ and washers 125 & 125′ fixed with C rings 126 & 126′.

For the sake of becoming a buffer for ascending/descending, one end of the connecting rod 121 inside the assembled supporting rod 12 is penetrated into the connector 110 of the hydraulic cylinder 11; the steel connecting rod 121 and the steel shaft 122 are securely inserted into the assembled device 120 for reinforcement of overall support and strength that makes further improvement compared with a known supporting device linked by iron materials with features of breaks, bend, and deformation easily.

Refer to the content shown in FIG. 5 and FIG. 6, which are views for movement of this invention of the new flatbed supporting device. With extension of the assembled device 120 via the hydraulic cylinder 11, there is less force necessary for movement of the flatbed supporting device 1 in virtue of the assembled device 120 with the lateral casing pipe 1202 penetrated by the shaft 122 and with plural bearings 123, 123′, 124, and 124′ as well as washers 125 & 125′ fixed by C rings 126 & 126′ along bulges 140 of the first holder 14 & bulges 150 of the second holder 15 by using plural bearings 123, 123′, 124, and 124′.

Refer to the content shown in FIG. 7 and FIG. 8, which are operational views of embodiment for the connecting rod or the shaft within the structure of this invention of the flatbed supporting device where the connecting rod 121 or the shaft 122 has holes 1210, 1210′, 1220, and 1220′ (not shown in both figures but in FIG. 3) for embodiment of penetration or has plural sockets 16 & 16′ or plural screw holes 17 & 17′ for employment of fixing with various styles of bolts.

In light of the abovementioned descriptions, it is of course to be understood that the embodiment described herein is merely illustrative of the principles of the invention but not restricted to ambits for implementation of the invention. Furthermore, a wide variety of modifications thereto may be affected by persons skilled in the art without departing from the spirit and scope of the invention as set forth in the following claims.

### BRIEF DESCRIPTION OF THE DRAWINGS

FIG. 1 is a three-dimensional view of the invention of the flatbed supporting device.

FIG. 2 is a three-dimensional exploded view of the invention of the flatbed supporting device.

FIG. 3 is an exploded view for the supporting device of the invention of the flatbed supporting device.

FIG. 4 is a view for assembly of the invention of the flatbed supporting device.

FIG. 5 is a view for movement of the invention of the flatbed supporting device.

FIG. 6 is a vertical view of the supporting device of the invention of the flatbed supporting device.

FIG. 7 is a view for embodiment of the connecting rod or the shaft of the invention of the flatbed supporting device.

FIG. 8 is a view of another embodiment of the connecting rod or the shaft of the invention of the flatbed supporting device.

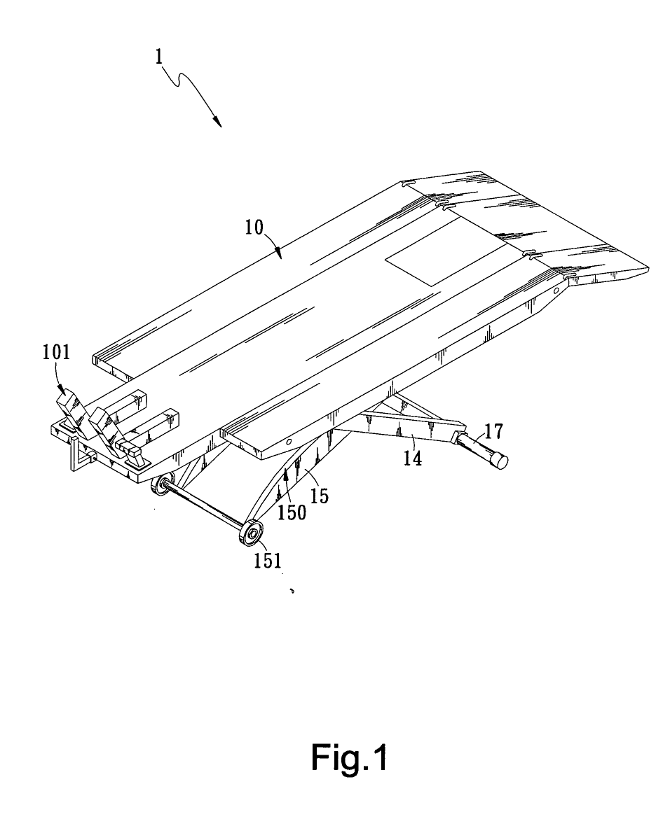

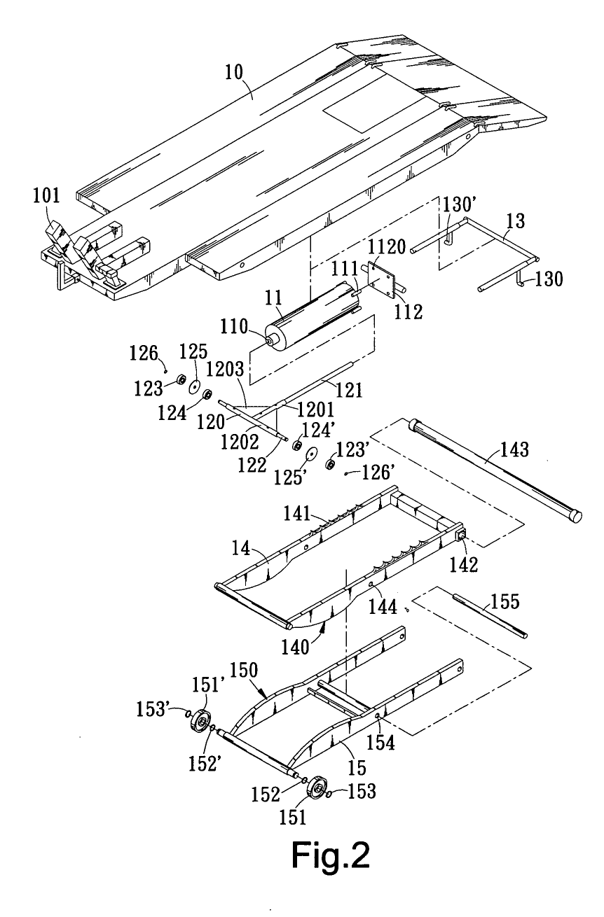

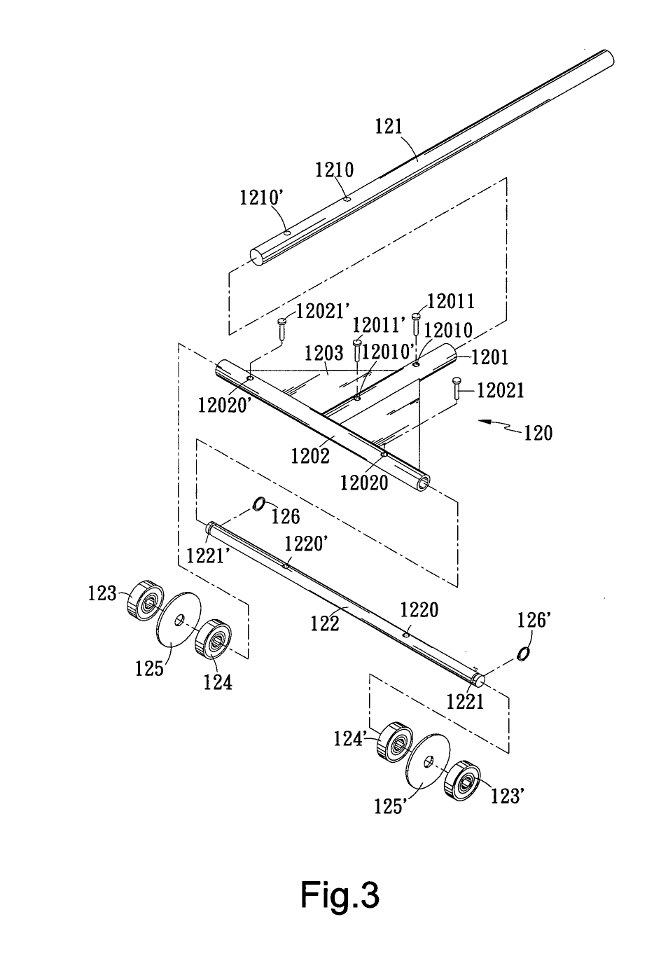

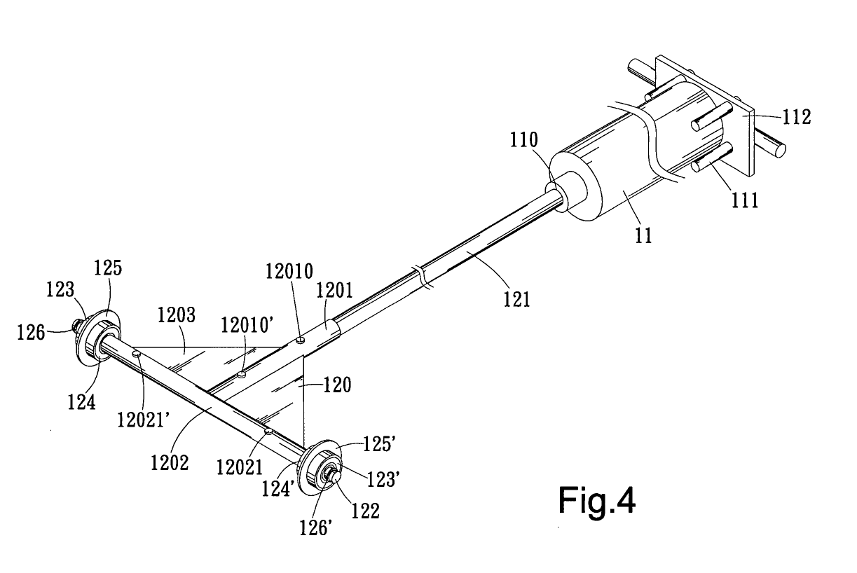

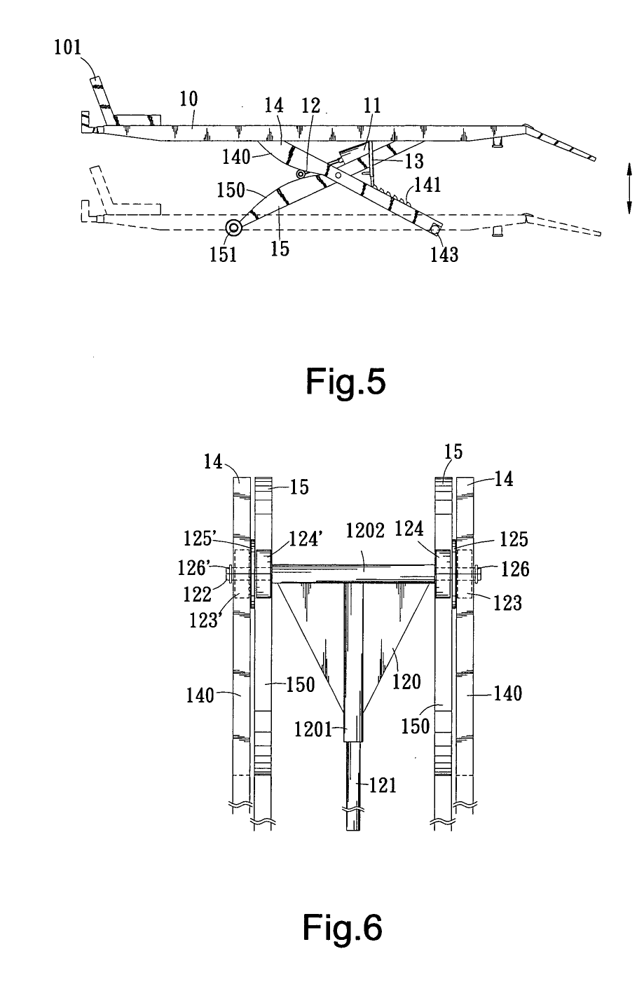

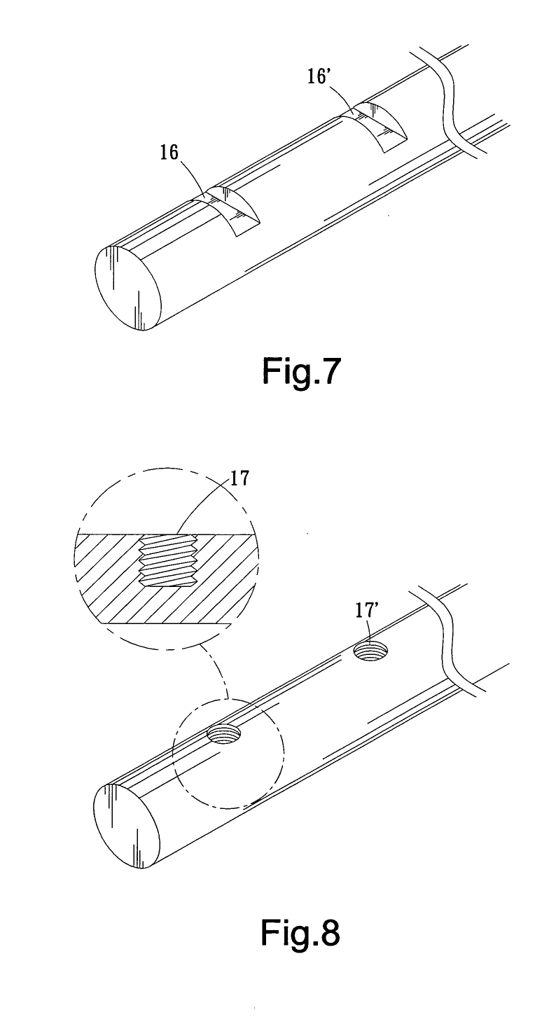

What is claimed is:

1. A flatbed supporting device is an assistant tool as a horizontal support device for reparation or maintenance of motorcycles and motor vehicles and is made up of a horizontal plate, a hydraulic cylinder, a supporting device, a fixing holder, a first holder and a second holder with following features:
a supporting device assembled with plural metal hardware includes an assembled device with a connecting rod as well as a shaft contained for penetration and fixed by plural bolts and has plural bearings and washers that are installed at both ends of the shaft and secured by C rings for overall reinforcement of the supporting device and without damages discovered after usage such as breaks, bend, or deformation in virtue of plural metal hardware as media for assembly of the supporting device.

2. The flatbed supporting device according to claim 1 where an assembled device is embodied with iron or steel.

3. The flatbed supporting device according to claim 1 where a connecting rod is embodied with iron or steel.

4. The flatbed supporting device according to claim 1 where a shaft is embodied with iron or steel.

5. The flatbed supporting device according to claim 1 where the connecting rod has plural holes.

6. The flatbed supporting device according to claim 5 where holes are embodied as sockets or screw holes.

7. The flatbed supporting device according to claim 1 where the shaft has plural holes.

8. The flatbed supporting device according to claim 7 where holes are embodied as sockets or screw holes.
